(19) United States
(12) Patent Application Publication
(10) Pub. No.: US 2013/0038747 A1
(43) Pub. Date: Feb. 14, 2013

(54) IMAGE PICKUP UNIT AND IMAGE PICKUP APPARATUS

(71) Applicant: Kotaro Ando, Saitama (JP)

(72) Inventor: Kotaro Ando, Saitama (JP)

(73) Assignee: Sony Corporation, Tokyo (JP)

(21) Appl. No.: 13/546,748

(22) Filed: Jul. 11, 2012

(30) Foreign Application Priority Data
Aug. 9, 2011 (JP) 2011-174302

(51) Int. Cl. H04N 5/225

(52) U.S. Cl. 348/222.1; 348/E05.024

(57) ABSTRACT

There is provided an image pickup unit including an image pickup element converting an optical image to an electrical signal, an optical member disposed on a subject side of the image pickup element, a plate joined to one edge of the optical member, and a vibrating member joined to the plate.

### BACKGROUND

The present disclosure relates to an image pickup unit and an image pickup apparatus. In more detail, the present disclosure relates to a technology that transmits vibration generated by a vibrating member via a plate to an optical member to prevent dust from adhering to the optical member regardless of the size of the vibrating member, and by doing so reduces manufacturing cost and also improves image quality.

Image pickup apparatuses such as video cameras and still cameras are internally equipped with an image pickup unit including an image pickup element such as a CDD (Charge Coupled Device) or a CMOS (Complementary Metal-Oxide Semiconductor). In an image pickup apparatus, image pickup is carried out by taking in an image of a subject via an optical system such as a lens and converting such optical image to an electrical signal using the image pickup element of the image pickup unit.

In addition to the image pickup element, the image pickup unit of an image pickup apparatus includes various types of optical member, such as a filter and/or infrared absorbing glass, which is/are disposed on the subject side of the image pickup element.

If dust adheres to the surface of an optical member in an image pickup apparatus, there is the risk of the dust producing shadows in the picked-up images and thereby causing a drop in image quality. In particular, in an image pickup apparatus such as an interchangeable lens-type still camera, the optical member becomes exposed when the attachment portion (or “lens mount”) is opened to change lenses, which increases the likelihood of dust adhering to the optical member.

For this reason, some image pickup apparatuses are equipped with a device that prevents dust from adhering to the surface of the optical member (see for example Japanese Laid-Open Patent Publications No. 2008-109708 and 2008-148342).

In the image pickup apparatuses disclosed in the cited publications, piezoelectric elements with the same length as the length in the length direction of a rectangular optical member are used as vibrating members and are joined to the long edges on both sides of the optical member. When power is supplied to the piezoelectric elements, the piezoelectric elements expand and contract mainly in the length direction and the vibration caused by such expansion and contraction is transmitted to the optical member, thereby causing the optical member to vibrate. Due to such vibration, dust is shaken off the surface of the optical member, thereby preventing the adhesion of dust to the optical member.

### SUMMARY

In the image pickup apparatuses according to the cited publications, a piezoelectric element is joined to the optical member and a piezoelectric element whose length is equal to the length in the length direction of the optical member is used to transmit vibration with a large amplitude to the entire optical member.

Although it is possible to transmit vibration with a large amplitude to the entire optical member by using a piezoelectric element with the same length as the length in the length direction of the optical member, vibrating members such as piezoelectric elements are costly, which results in the problem of an increase in the manufacturing cost of an image pickup apparatus due to the use of a long vibrating member.

Meanwhile, if a vibrating member that is shorter than the short edges of the optical member is used as the vibrating member joined to the optical member, the amplitude of the vibration will become smaller, resulting in the necessary vibration not being transmitted to the optical members, an inability to sufficiently prevent dust from adhering, and a drop in image quality.

Accordingly, the image pickup unit and the image pickup apparatus according to an embodiment of the present disclosure were conceived to solve such problem and aim to reduce manufacturing cost and also improve image quality.

According to an embodiment of the present disclosure, there is provided an image pickup unit including: an image pickup element converting an optical image to an electrical signal; an optical member disposed on a subject side of the image pickup element; a plate joined to one edge of the optical member; and a vibrating member joined to the plate.

Accordingly, in this image pickup unit, vibration of a large amplitude is transmitted via the plate to the optical member.

In the image pickup unit described above, the vibrating member should preferably be formed in a shape that extends in a length direction of the one edge of the optical member, and a length of the vibrating member should preferably be set shorter than a length of the one edge of the optical member.

By forming the vibrating member in a shape that extends in a length direction of the one edge of the optical member and setting a length of the vibrating member shorter than a length of the one edge of the optical member, it is possible to use a low-cost vibrating member.

In the image pickup unit described above, the optical member should preferably be formed in a rectangular shape, and a long edge of the optical member should preferably be set as the one edge.

By forming the optical member in a rectangular shape and setting a long edge of the optical member as the one edge, vibration of a large amplitude is transmitted to the entire optical member.

In the image pickup unit described above, the plate should preferably be formed of a metal material.

By forming the plate of a metal material, the plate transmits vibration more favorably.

In the image pickup unit described above, the optical member should preferably be held by being sandwiched between a pressing plate and a support member, and a space should preferably be formed between (i) the support member and (ii) the plate and the vibrating member.

By holding the optical member so as to be sandwiched between a pressing plate and a support member and having a space formed between (i) the support member and (ii) the plate and the vibrating member, the support member will not contact the plate or the vibrating member.

In the image pickup unit described above, the optical member should preferably be held by being sandwiched between a pressing plate and a support member, and a space should preferably be formed between (i) the pressing plate and (ii) the plate and the vibrating member.

By holding the optical member so as to be sandwiched between a pressing plate and a support member and having a space formed between (i) the pressing plate and (ii) the plate and the vibrating member, the pressing plate will not contact the plate or the vibrating member.

In the image pickup unit described above, the optical member should preferably be held by being sandwiched between a pressing plate and a support member, the plate should preferably be joined to a surface on an opposite side of the optical member to a surface pressed by the pressing plate, and the vibrating member should preferably be positioned between the surface of the optical member pressed by the pressing member and the surface on the opposite side of the optical member.

By joining the plate to a surface on an opposite side of the optical member to a surface pressed by the pressing plate and positioning the vibrating member between the surface of the optical member pressed by the pressing member and the surface on the opposite side of the optical member, there is no increase in the length in the optical axis direction of the image pickup unit due to the vibrating member being disposed.

In the image pickup unit described above, a piezoelectric element should preferably be provided as the vibrating member.

By providing a piezoelectric element as the vibrating member, the size of the vibration is changed according to the amount of power supplied to the vibrating member.

In the above image pickup unit, an infrared absorbing member should preferably be provided as the optical member.

By providing an infrared absorbing member as the optical member, infrared light is absorbed by the optical member.

According to another embodiment of the present disclosure, an image pickup apparatus includes an image pickup unit carrying out specified processing to form an image for an optical image received via an optical system inside an external housing, the image pickup unit including an image pickup element converting the optical image to an electrical signal, an optical member disposed on a subject side of the image pickup element, a plate joined to one edge of the optical member, and a vibrating member joined to the plate.

Accordingly, in this image pickup apparatus, vibration of a large amplitude is transmitted via the plate to the optical member.

According to an embodiment of the present disclosure, an image pickup unit includes an image pickup element converting an optical image to an electrical signal, an optical member disposed on a subject side of the image pickup element, a plate joined to one edge of the optical member; and a vibrating member joined to the plate.

Accordingly, since it is possible to transmit vibration of a large amplitude to the optical member and sufficiently prevent adhesion of dust to the optical member regardless of the size of the vibrating member, it is possible to reduce the manufacturing cost and to also improve image quality.

In the above image pickup unit, the vibrating member may be formed in a shape that extends in a length direction of the one edge of the optical member, and a length of the vibrating member may be set shorter than a length of the one edge of the optical member.

Accordingly, it is possible to use a low-cost vibrating member, which makes it possible to significantly reduce the manufacturing cost of the image pickup unit.

In the above image pickup unit, the optical member may be formed in a rectangular shape, and a long edge of the optical member may be set as the one edge.

Accordingly, it is possible to transmit vibration with a large amplitude to the entire optical member, which makes it possible to increase the effect of preventing the adhesion of dust to the optical member and to significantly improve image quality.

In the above image pickup unit, the plate may be formed of a metal material.

Accordingly, the vibration is favorably transmitted and it is possible to transmit vibration of a large amplitude to the entire optical member.

In the above image pickup unit, the optical member may be held by being sandwiched between a pressing plate and a support member, and a space should preferably be formed between (i) the support member and (ii) the plate and the vibrating member.

Accordingly, the support member will not contact the plate or the vibrating member, which makes it possible to suppress attenuation of the vibration transmitted from the vibrating member to the optical member.

In the above image pickup unit, the optical member may be held by being sandwiched between a pressing plate and a support member, and a space may be formed between (i) the pressing plate and (ii) the plate and the vibrating member.

Accordingly, the pressing plate will not contact the plate and the vibrating member, which makes it possible to suppress attenuation of the vibration transmitted from the vibrating member to the optical member.

In the above image pickup unit, the optical member may be held by being sandwiched between a pressing plate and a support member, the plate may be joined to a surface on an opposite side of the optical member to a surface pressed by the pressing plate, and the vibrating member may be positioned between the surface of the optical member pressed by the pressing member and the surface on the opposite side of the optical member.

Accordingly, there is no increase in the length in the thickness (optical axis) direction of the image pickup unit even due to the vibrating member being disposed, which means that the image pickup unit can be made slimmer through efficient use of space.

In the above image pickup unit, a piezoelectric element may be provided as the vibrating member.

Accordingly, it is possible to simplify the control relating to the generation of vibration and to increase the freedom of such control.

In the above image pickup unit, an infrared absorbing member may be provided as the optical member.

Accordingly, in addition to preventing dust from adhering, it is possible to improve image quality by absorbing infrared light.

An image pickup apparatus according to an embodiment of the present disclosure includes an image pickup unit carrying out specified processing to form an image for an optical image received via an optical system inside an external housing, the image pickup unit including an image pickup element converting the optical image to an electrical signal, an optical member disposed on a subject side of the image pickup element, a plate joined to one edge of the optical member, and a vibrating member joined to the plate.

Accordingly, since it is possible to transmit vibration with a large amplitude to the optical member and sufficiently prevent adhesion of dust to the optical member regardless of the size of the vibrating member, it is possible to reduce the manufacturing cost and to also improve image quality.

### BRIEF DESCRIPTION OF THE DRAWINGS

FIG. 1 is a simplified perspective view of an image pickup apparatus and an interchangeable lens according to a preferred embodiment of the present disclosure;

FIG. 2 is an exploded perspective view of an image pickup unit according to the same embodiment;

FIG. 3 is a cross-sectional view of the image pickup unit;

FIG. 4 is an enlarged cross-sectional view showing part of the image pickup unit;

FIG. 5 is an enlarged front view of an optical member, a plate, and a vibrating member;

FIG. 6 is a diagram showing the functioning of a piezoelectric element, which is used as the vibrating member, and the plate; and

FIG. 7 is a block diagram of the image pickup apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the preferred embodiments of the present disclosure described below, an image pickup apparatus according to an embodiment of the present disclosure is adapted to an interchangeable lens-type still camera and the image pickup unit according to an embodiment of the present disclosure is adapted to an image pickup unit provided in such a still camera. Note however that the present disclosure is not limited to an interchangeable lens-type still camera or an image pickup unit provided in an interchangeable lens-type still camera. The present disclosure can be widely applied to various types of image pickup apparatus such as other types of still camera, a video camera, and a camera incorporated in another device such as a mobile phone, and to image pickup units provided in such various types of image pickup apparatus.

In the following description, the expressions “front”, “rear”, “up”, “down”, “left”, and “right” refer to directions relative to the direction in which a photographer looks when taking photographs using a still camera. Accordingly, the subject side of the still camera is the “front” and the photographer side is the “rear”.

Note also that such “front”, “rear”, “up”, “down”, “left”, and “right” directions are used merely for ease of explanation in the following description and that the present disclosure is not limited to such directions.

### Configuration of Image Pickup Apparatus

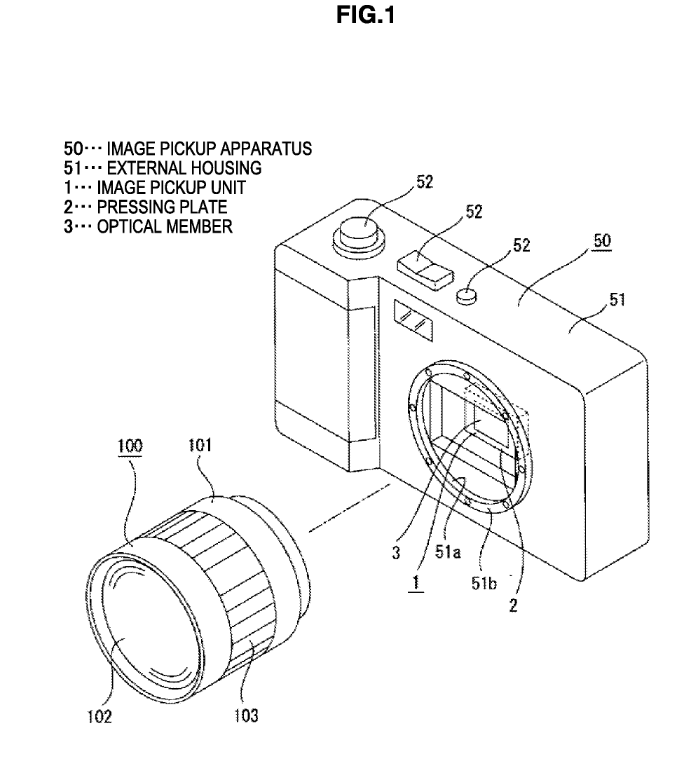

An image pickup apparatus 50 is configured by disposing various components inside and outside an external housing 51 (see FIG. 1). Various operation portions 52, 52, . . . are disposed on the outer surface of the external housing 51. As examples, the operation portions 52, 52, . . . include a power button, a shutter button, a zoom switch, a mode switching knob, and the like.

Various components such as a display panel (for example, a liquid crystal panel, not shown), and a viewfinder are provided on the image pickup apparatus 50.

An opening 51a is formed in a front surface of the external housing 51 and an edge part around the opening 51a is provided as an attachment portion 51b for attaching an interchangeable lens 100.

The interchangeable lens 100 has a plurality of lens groups including a front lens element 102 disposed inside a lens barrel 101. A zoom ring 103 for changing the magnification is rotatably supported on the lens barrel 101. By rotating the zoom ring 103, it is possible to move the lens groups disposed inside the lens barrel 101 in the optical axis direction and thereby carry out zooming.

An image pickup unit 1 is disposed inside the external housing 51 at a position behind the opening 51a.

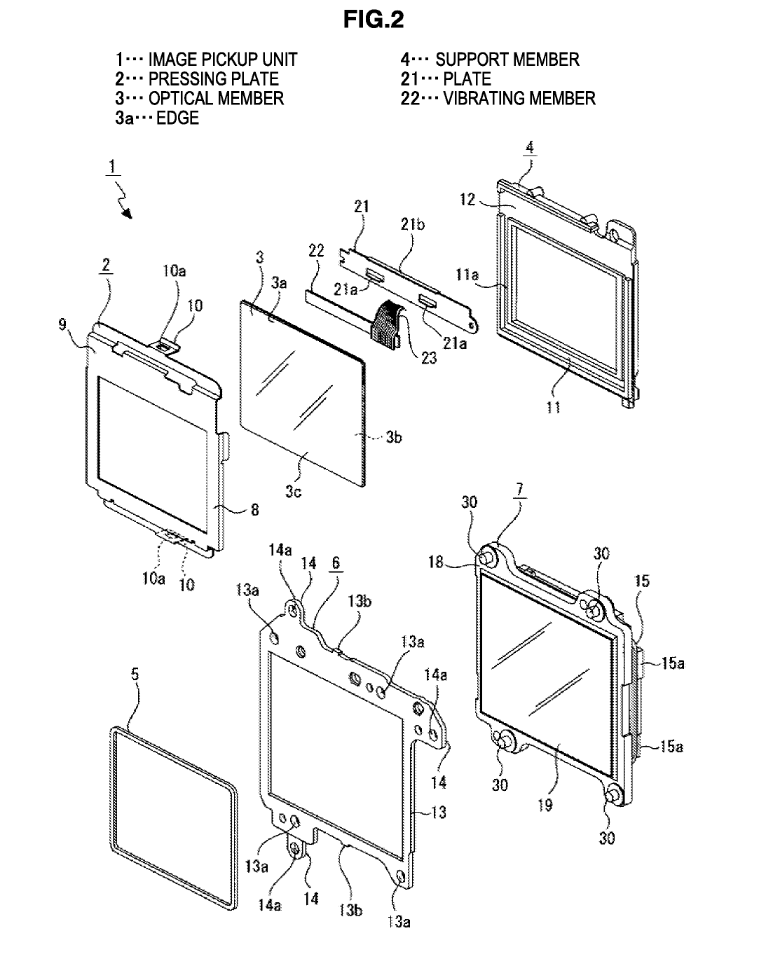

The image pickup unit 1 includes a pressing plate 2, an optical member 3, a support member 4, a seal frame 5, a base frame 6, and an element unit 7 that are disposed in that order from the front (see FIGS. 2 to 4).

The pressing plate 2 includes a pressing portion 8 formed as a rectangular frame and a shielding portion 9 that protrudes upward from the pressing portion 8. Attachment tabs 10, 10 that protrude to the rear are provided both above the shielding portion 9 and below the pressing portion 8, with attachment holes 10a, 10a being formed so as to pass through the attachment tabs 10, 10 in the up-down direction.

The optical member 3 has an external form that is slightly smaller than the external form of the pressing portion 8 of the pressing plate 2 and as one example is formed as a rectangular plate whose length is oriented in the left-right direction. As one example, the optical member 3 is infrared absorbing glass (or an “infrared absorbing member”). However, the optical member 3 is not limited to infrared absorbing glass, and as the optical member 3, it is also possible to use another member such as glass or resin formed of a transparent material, glass or resin that absorbs one or more components out of the incident light, or glass or resin that scatters or focuses the incident light. Also, aside from a plate-like material, it is also possible to use a material with a narrow thickness, such as a film or a sheet, as the optical member 3.

Note that the optical member 3 may also have an absorbing effect for ultraviolet light as well as infrared light.

The support member 4 functions as a spacer and includes a pressing/holding portion 11 formed as a rectangular frame and a support surface portion 12 that protrudes upward from the pressing/holding portion 11. A pressing protruding portion 11a that protrudes forward is provided on an inner circumferential portion of the pressing/holding portion 11. A seal groove 11b that is open to the rear is formed on a rear surface of an inner circumferential portion of the pressing/holding portion 11.

The seal frame 5 is formed as a rectangular frame whose length is oriented in the left-right direction, and is formed using an elastic material such as rubber. The seal frame 5 is formed with the same size as the seal groove 11b of the support member 4.

The base frame 6 includes a frame portion 13 formed as a rectangular frame and attachment protrusion portions 14, 14, 14 that protrude from the frame portion 13 upward, downward, and to the side, respectively. Connecting holes 13a, 13a, . . . are formed in the frame portion 13. Engagement tabs 13b, 13b that protrude respectively upward and downward are provided on both upper and lower end portions of the base frame 6. Insertion holes 14a, 14a, 14a are formed in the attachment protrusion portions 14, 14, 14, respectively.

The support member 4 is joined to the base frame 6. The support member 4 is joined to the base frame 6 in a state where the seal frame 5 is inserted into the seal groove 11b.

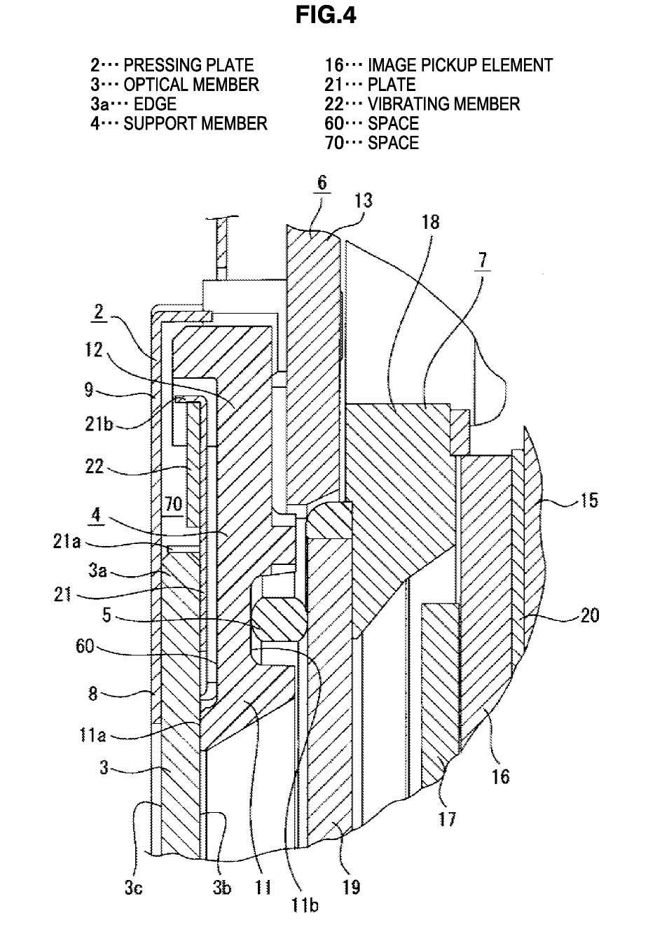

The optical member 3 is held by being sandwiched from the front and the rear by the pressing portion 8 of the pressing plate 2 and the pressing/holding portion 11 of the support member 4. The optical member 3 is held with the pressing portion 8 in contact with an outer circumferential portion of the front surface and the pressing protruding portion 11a of the pressing/holding portion 11 in contact with a position near an outer periphery of the rear surface (see FIG. 4). Accordingly, a space 60 is formed between an outer circumferential portion of the rear surface of the optical member 3 and the pressing/holding portion 11.

The pressing plate 2 is joined to the base frame 6 by inserting and engaging the joining tabs 13b, 13b in the attachment holes 10a, 10a of the attachment tabs 10, 10.

The element unit 7 includes a substrate 15, an image pickup element 16, a frame 18, and a low pass filter 19 (see FIGS. 2 to 4).

A plurality of electronic components 15a, 15a, . . . are mounted on a rear surface of the substrate 15.

The image pickup element 16 is joined to a front surface of the substrate 15 using conductive solder 20.

The image pickup element 16 functions so as to convert an optical image to an electrical signal. As examples, a CCD (Charge Coupled Device), a CMOS (Complementary Metal-Oxide Semiconductor), or the like is used as the image pickup element 16.

Screws 30, 30, . . . are attached to the frame 18.

A part 17 positioned on the front side of the image pickup element 16 which is disposed on the front surface side of the substrate 15 is inserted into an opening in the frame 18.

The low pass filter 19 is attached to a front surface of the frame 18 and is disposed so as to cover the opening in the frame 18.

The element unit 7 is joined to the base frame 6 by inserting the screws 30, 30, . . . into the respective connecting holes 13a, 13a, . . . formed in the frame portion 13 and crimping. In a state where the element unit 7 has been joined to the base frame 6, the low pass filter 19 will be positioned inside the opening in the base frame 6.

A plate 21 is joined by adhesive or the like to one edge 3a, for example an upper edge that extends in the length direction, of the optical member 3.

Note that if it is not possible to join the plate 21 to the upper edge of the optical member 3 for a reason such as the disposed positions of other components of the image pickup unit 1, the plate 21 may be joined to a lower edge, a left side edge, or a right side edge of the optical member 3. It is also possible to join a plurality of plates 21, 21, . . . respectively to two or more positions on the upper edge, the lower edge, the left side edge, or the right side edge of the optical member 3.

As one example, the plate 21 is formed of a plate-like metal material and has a length that is equal to or greater than the length in the left-right direction of the edge 3a. Positioning tabs 21a, 21a that are formed by cutting and bending up parts of the plate 21 toward the front are provided so as to be separated in the left-right direction. A pressing tab 21b formed by bending an upper end portion forward is provided on the plate 21.

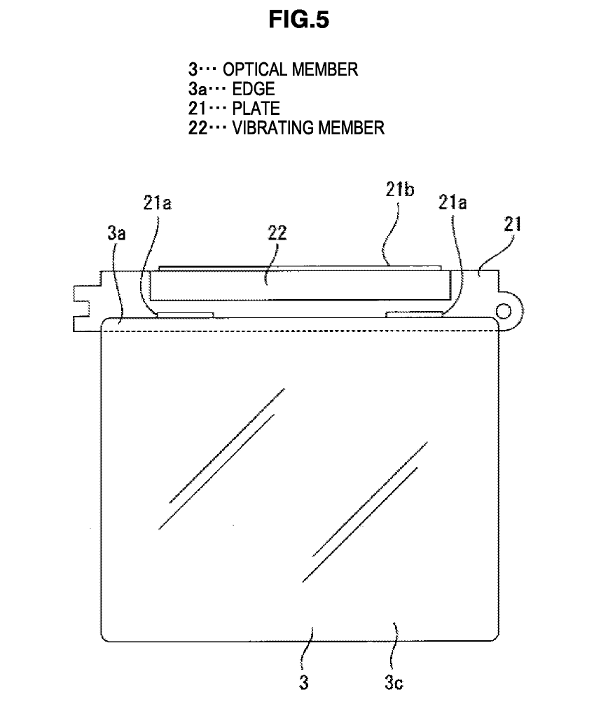

In a state where the plate 21 is positioned by the positioning tabs 21a, 21b contacting the upper surface of the optical member 3, a part that is substantially the lower half of the plate 21 (except for both left and right edge portions) is joined to the edge 3a on the rear surface 3b of the optical member 3 (see FIG. 5). Accordingly, a part that is substantially the upper half of the plate 21 is positioned above the optical member 3.

The part of the plate 21 joined to the optical member 3 is positioned in the space 60 formed between the optical member 3 and the support member 4 and the part of the plate 21 positioned above the optical member 3 is positioned in a space 70 formed between the shielding portion 9 of the pressing plate 2 and the pressing/holding portion 11 of the support member 4 (see FIG. 4). The plate 21 is positioned in the space 70 in a state where the plate 21 is in front of and separated from the support member 4. The plate 21 is also positioned in the space 70 in a state where the plate 21 is behind and separated from the pressing plate 2.

A vibrating member 22 is joined by adhesive or the like to an upper end portion of the front surface of the plate 21. The vibrating member 22 is formed as a rectangular plate that extends in the left-right direction. As one example, a piezoelectric element is used as the vibrating member 22. By supplying power to the vibrating member 22, the vibrating member 22 is caused to expand and contract mainly in the left-right direction (the length direction), so that the vibrating member 22 functions as a vibratory source for generating vibration. Note that the vibrating member 22 is not limited to a piezoelectric element and it is possible to use any member that can act as a source of vibration. As examples, it is possible to use a magnetostrictive element that acts as a vibratory source due to distortion produced by a magnetic force, or a composite element in which a piezoelectric element and a magnetostrictive element are combined.

The length in the length direction of the vibrating member 22 is shorter than the length of the edge 3a of the optical member 3. Note that if the vibrating member 22 is disposed on one or both of the left and right side edges of the optical member 3 via the plate 21, the length in the length direction of the vibrating member 22 is set shorter than the length of the side edges of the optical member 3.

The vibrating member 22 is joined to the plate 21 in a state where the upper surface of the vibrating member 22 is pressed from below onto the pressing tab 21b.

As one example, one end of a conductive member 23 such as a flexible printed circuit board is connected to the vibrating member 22 and another end of the conductive member 23 is connected to a power supply unit of the circuit board, not shown, disposed inside the external housing 51. Accordingly, it is possible to supply power from the power supply unit via the conductive member 23 to the vibrating member 22 to cause the vibrating member 22 to expand and contract, thereby generating vibration.

In a state where the plate 21 is joined to the edge 3a of the optical member 3, the vibrating member 22 is positioned in the space 70 between the front surface 3c and the rear surface 3b of the optical member 3 (i.e., between straight lines produced by extending the front surface 3c and the rear surface 3b).

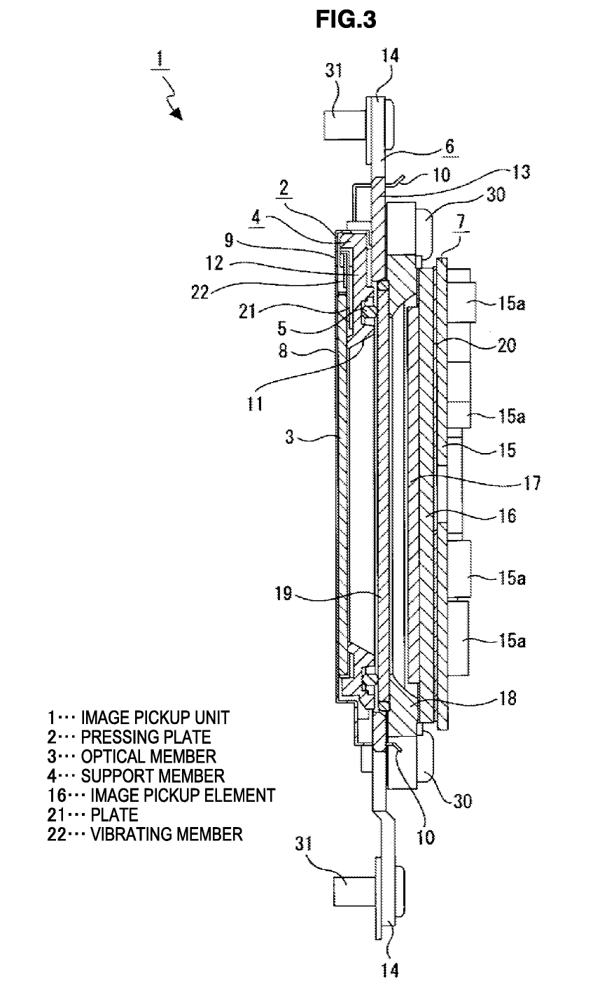

The image pickup unit 1 configured as described above is attached to an attachment portion, not shown provided inside the external housing 51 via screws 31, 31, 31 (see FIG. 3) that pass through the through-holes 14a, 14a, 14a formed in the attachment protrusion portions 14, 14, 14 of the base frame 6. In a state where the image pickup unit 1 has been attached inside the external housing 51, the front surface 3c of the optical member 3 present on the subject side is positioned directly behind the opening 51a of the external housing 51 (see FIG. 1).

### Operation of Image Pickup Unit

In the image pickup unit 1, when power is supplied from the power supply unit to the vibrating member 22 via the conductive member 23, the vibrating member 22 expands and contracts and thereby generates vibration. The generated vibration is transmitted via the plate 21 to the entire optical member 3.

When the vibration is transmitted to the optical member 3, dust that has adhered to or is resting on the surface (front surface 3c) of the optical member 3 is shaken off the surface of the optical member 3 by the vibration to prevent adhesion of dust to the optical member 3. Accordingly, dust will not appear in picked-up images as shadows, thereby improving the quality of the picked-up images.

### Measurement Data

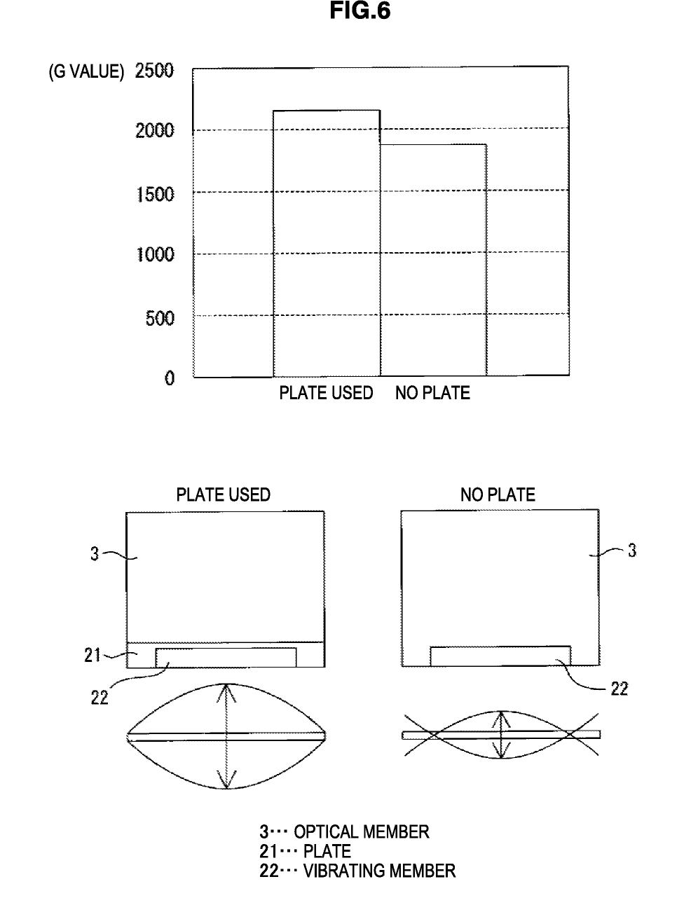

Evaluation data relating to the functioning of the piezoelectric element used as the vibrating member 22 and the plate 21 will now be described (see FIG. 6).

Such evaluation was carried out by measuring a G value (vibration acceleration) produced in the optical member 3 due to the vibration when the plate 21 joined to the vibrating member 22 is joined to the optical member 3 and the G value produced in the optical member 3 due to the vibration when the vibrating member 22 is joined to the optical member 3 with no plate 21 included.

During such measurement, the G value was measured (calculated) using an average of measurements of 391 points of the optical member 3 using a Doppler interferometer. The length of the vibrating member 22 was set shorter than the length in the length direction of the optical member 3, and the vibration frequency was set at around 60 KHz.

As shown in FIG. 6, the G value of the optical member 3 joined to the plate 21 was larger than the G value of the optical member 3 joined to the vibrating member 22, with the G value of the optical member 3 joined to the plate 21 at 2156 G and the G value of the optical member 3 joined to the vibrating member 22 at 1864 G.

As shown at the bottom in FIG. 6, it is thought that this difference between the generated G values is due to the amplitude nodes of the optical member 3 to which the plate 21 is joined lying at both ends in the length direction of the plate 21, so that the amplitude increases, resulting in an increase in G value, while the amplitude nodes of the optical member 3 to which the vibrating member 22 is joined lie at both ends in the length direction of the vibrating member 22, so that the amplitude decreases, resulting in a decrease in G value.

From the measurement results described above, an evaluation was obtained showing that even when the length of the vibrating member 22 is shorter than the length of the optical member 3, by transmitting vibration from the vibrating member 22 via the plate 21 to the optical member 3, vibration with a large amplitude is transmitted to the optical member 3.

### Embodiment as Image Pickup Apparatus

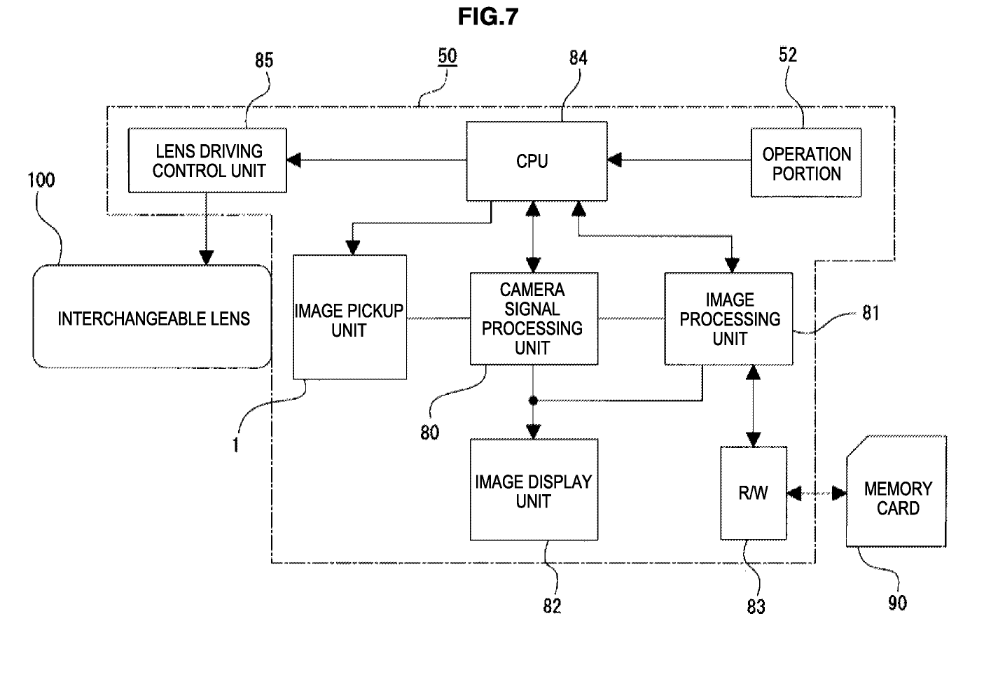

FIG. 7 is a block diagram showing a still camera as an embodiment of an image pickup apparatus according to an embodiment of the present disclosure.

The image pickup apparatus (still camera) 50 includes a camera signal processing unit 80 that carries out signal processing such as analog-digital conversion of a picked-up image signal and an image processing unit 81 that carries out a recording/reproduction process for image signals. The image pickup apparatus 50 also includes an image display unit 82, such as a liquid crystal panel, displaying picked-up images and the like, an R/W (reader/writer) 83 that carries out writing and reading of image signals on a memory card 90, a CPU (Central Processing Unit) 84 that controls the entire image pickup apparatus 50, the operation portions 52 composed of a variety of switches that enable the user to carry out specified operations, and a lens driving control unit 85 that drives the various lens groups disposed in the interchangeable lens 100 attached to the image pickup apparatus 50.

The camera signal processing unit 80 carries out various signal processing on an output signal from the image pickup unit 1, such as conversion to a digital signal, noise reduction, image quality enhancement, and conversion to a luminance/color difference signal

The image processing unit 81 carries out processing such as compression encoding or expansion decoding of image signals based on a specified image data format or a conversion process relating to the data specification, such as resolution.

The image display unit 82 has a function that displays an operation state of the user for the operation portions 52 and displays various data on picked-up images or the like.

The R/W 83 carries out the writing of image data encoded by the image processing unit 81 onto the memory card 90 and the reading of image data recorded on the memory card 90.

The CPU 84 functions as a control processing unit that controls various circuit blocks provided in the image pickup apparatus 50 and controls the various circuit blocks based on an instruction input signal and the like from the operation portions 52.

The lens driving control unit 85 controls a motor or the like, not shown, that drives the respective lens groups of the interchangeable lens 100 based on control signals from the CPU 84.

As one example, the memory card 90 is a semiconductor memory that can be detachably attached to a slot connected to the R/W 83.

The operation of the image pickup apparatus 50 will now be described.

In a standby state where image pickup is awaited, under the control of the CPU 84, a picked-up image signal is outputted via the camera signal processing unit 80 to the image display unit 82 and is displayed as a live preview. When an instruction input signal for zooming is inputted from the operation portions 52, the CPU 84 outputs a control signal to the lens driving control unit 85 and the respective lens groups of the interchangeable lens 100 are moved based on control by the lens driving control unit 85.

If the shutter of the image pickup apparatus 50 is operated according to an instruction input signal from the operation portions 52, the picked-up image signal is outputted from the camera signal processing unit 80 to the image processing unit 81 and subjected to a compression encoding process and converted to digital data of a specified data format. The converted data is outputted to the R/W 83 and is written onto the memory card 90.

Focusing is carried out by the lens driving control unit 85 moving the respective lens groups of the interchangeable lens 100 based on a control signal from the CPU 84.

When reproducing image data recorded on the memory card 90, in accordance with an operation of the operation portions 52, specified image data is read from the memory card 90 by the R/W 83, an expansion decoding process is carried out by the image processing unit 81, and a reproduction image signal is outputted to the image display unit 82 to have a reproduced image displayed.

### Conclusion

As described above, in the image pickup unit 1, the plate 21, which is formed with a length that is equal to or longer than the edge 3a of the optical member 3 and is joined to such edge 3a, is also joined to the vibrating member 22 so that the vibration generated by the vibrating member 22 is transmitted via the plate 21 to the optical member 3.

Accordingly, it is possible to transmit vibration of a large amplitude to the optical member 3 and sufficiently prevent dust from adhering to the optical member 3 regardless of the size of the vibrating member 22. This means that it is possible to reduce the manufacturing cost and to also improve image quality.

Also, since the length of the vibrating member 22 is shorter than the length of the edge 3a of the optical member 3, it is possible to use a low-cost vibrating member 22, which makes it possible to significantly reduce the manufacturing cost of the image pickup unit 1.

In addition, by joining the plate 21 to the edge (long edge) 3a that extends in the length direction of the optical member 3, it is possible to transmit vibration of a large amplitude to the entire optical member 3, which makes it possible to increase the effect of preventing the adhesion of dust to the optical member 3 and to significantly improve image quality.

In addition, since the plate 21 is formed of a metal material, the vibration is favorably transmitted and it is possible to transmit vibration of a large amplitude to the entire optical member 3.

Also, since the space 60 is formed between the support member 4 and the plate 21 in a state where the optical member 3 is held by being sandwiched between the pressing plate 2 and the support member 4, the support member 4 will not contact the vibrating member 22 or the plate 21, which makes it possible to suppress attenuation of the vibration transmitted from the vibrating member 22 to the optical member 3.

In addition, the vibrating member 22 and the plate 21 are disposed in the space 70 formed between the pressing plate 2 and the support member 4 so that the pressing plate 2 does not contact the vibrating member 22 or the plate 21, which makes it possible to suppress attenuation of the vibration transmitted from the vibrating member 22 to the optical member 3.

In addition, since the vibrating member 22 is disposed between the front surface 3c and the rear surface 3b of the pressing plate 2, there is no increase in the thickness (i.e., the length in the front-rear direction) of the image pickup unit 1 due to the vibrating member 22 being disposed, which means that the image pickup unit 1 can be made slimmer through efficient use of space.

Note that since the piezoelectric element used as the vibrating member 22 is a device where the size of the vibration can be changed according to the amount of supplied power, by using a piezoelectric element as the vibrating member 22, it is possible to simplify the control relating to the generation of vibration and to increase the freedom of such control.

By using an infrared absorbing member as the optical member 3, in addition to preventing dust from adhering, it is possible to improve image quality by absorbing infrared light.

Note that since the vibrating member 22 is joined to the plate 21 as described above, by holding the plate 21 during the assembly process for the various components of the image pickup unit 1, it becomes no longer necessary to hold the vibrating member 22, which makes it possible to prevent damage to the vibrating member 22 during the assembly process.

[Present Technology]

The present technology may be configured as below.
(1) An image pickup unit including:

an image pickup element converting an optical image to an electrical signal;

an optical member disposed on a subject side of the image pickup element;

a plate formed with a length that is equal to or longer than one edge of the optical member and joined to the one edge of the optical member; and

a vibrating member functioning as a vibratory source for generating vibration and transmitting the vibration generated by being joined to the plate via the plate to the optical member.
(2) The image pickup unit according to (1),

wherein the vibrating member is formed in a shape that extends in a length direction of the one edge of the optical member, and

wherein a length of the vibrating member is set shorter than a length of the one edge of the optical member.
(3) The image pickup unit according to (1) or (2),

wherein the optical member is formed in a rectangular shape, and

wherein a long edge of the optical member is set as the one edge.
(4) The image pickup unit according to any one of (1) to (3),

wherein the plate is formed of a metal material.
(5) The image pickup unit according to any one of (1) to (4),

wherein the optical member is held by being sandwiched between a pressing plate and a support member, and

wherein a space is formed between: the support member; and the plate and the vibrating member.
(6) The image pickup unit according to any one of (1) to (5),

wherein the optical member is held by being sandwiched between a pressing plate and a support member, and

wherein a space is formed between: the pressing plate; and the plate and the vibrating member.
(7) The image pickup unit according to any one of (1) to (6),

wherein the optical member is held by being sandwiched between a pressing plate and a support member,

wherein the plate is joined to a surface on an opposite side of the optical member to a surface pressed by the pressing plate, and

wherein the vibrating member is positioned between the surface of the optical member pressed by the pressing member and the surface on the opposite side of the optical member.
(8) The image pickup unit according to any one of (1) to (7),

including a piezoelectric element as the vibrating member.
(9) The image pickup unit according to any one of (1) to (8),

including an infrared absorbing member as the optical member.
(10) An image pickup apparatus including

an image pickup unit carrying out specified processing to form an image for an optical image received via an optical system inside an external housing,

the image pickup unit including
an image pickup element converting the optical image to an electrical signal,
an optical member disposed on a subject side of the image pickup element,
a plate formed with a length that is equal to or longer than one edge of the optical member and joined to the one edge of the optical member, and
a vibrating member functioning as a vibratory source for generating vibration and transmitting the vibration generated by being joined to the plate via the plate to the optical member.

The specific forms and configurations of the respective elements in the preferred embodiments of the present disclosure described above show mere examples that may be used when the present disclosure is implemented. It should be understood by those skilled in the art that various modifications, combinations, sub-combinations and alterations may occur depending on design requirements and other factors insofar as they are within the scope of the appended claims or the equivalents thereof

The present disclosure contains subject matter related to that disclosed in Japanese Priority Patent Application JP 2011-174302 filed in the Japan Patent Office on Aug. 9, 2011, the entire content of which is hereby incorporated by reference.

What is claimed is:

1. An image pickup unit comprising:
an image pickup element converting an optical image to an electrical signal;
an optical member disposed on a subject side of the image pickup element;
a plate joined to one edge of the optical member; and
a vibrating member joined to the plate.

2. The image pickup unit according to claim 1,
wherein the vibrating member is formed in a shape that extends in a length direction of the one edge of the optical member, and
wherein a length of the vibrating member is set shorter than a length of the one edge of the optical member.

3. The image pickup unit according to claim 1,
wherein the optical member is formed in a rectangular shape, and
wherein a long edge of the optical member is set as the one edge.

4. The image pickup unit according to claim 1,
wherein the plate is formed of a metal material.

5. The image pickup unit according to claim 1,
wherein the optical member is held by being sandwiched between a pressing plate and a support member, and
wherein a space is formed between: the support member; and the plate and the vibrating member.

6. The image pickup unit according to claim 1,
wherein the optical member is held by being sandwiched between a pressing plate and a support member, and
wherein a space is formed between: the pressing plate; and the plate and the vibrating member.

7. The image pickup unit according to claim 1,
wherein the optical member is held by being sandwiched between a pressing plate and a support member,
wherein the plate is joined to a surface on an opposite side of the optical member to a surface pressed by the pressing plate, and
wherein the vibrating member is positioned between the surface of the optical member pressed by the pressing member and the surface on the opposite side of the optical member.

8. The image pickup unit according to claim 1,
comprising a piezoelectric element as the vibrating member.

9. The image pickup unit according to claim 1,
comprising an infrared absorbing member as the optical member.

10. An image pickup apparatus comprising
an image pickup unit carrying out specified processing to form an image for an optical image received via an optical system inside an external housing,
the image pickup unit including
an image pickup element converting the optical image to an electrical signal,
an optical member disposed on a subject side of the image pickup element,
a plate joined to one edge of the optical member, and
a vibrating member joined to the plate.
